(19) United States
(12) Patent Application Publication
(10) Pub. No.: US 2009/0097145 A1
(43) Pub. Date: Apr. 16, 2009

(54) DISPLAY FILTER AND DISPLAY MODULE PROVIDED THEREWITH

(75) Inventors: Atsunobu Fujii, Kusatsu-shi (JP); Hideki Chujo, Otokuni-gun (JP); Soichi Matsushita, Yokohama-shi (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi (JP)

(21) Appl. No.: 12/246,698

(22) Filed: Oct. 7, 2008

(30) Foreign Application Priority Data
Oct. 10, 2007 (JP) 2007-264375

(51) Int. Cl. G02B 5/22

(52) U.S. Cl. 359/885

(57) ABSTRACT

An embodiment of the invention provides a display filter, in which plural design patterns are independently illuminated and displayed and aesthetics is not lost during turn-off of a source light beam, and a display module provided with the display filter. The display filter includes plural design pattern filters and a blindfold filter. The blindfold filter is disposed on a visibility side opposite a light source, and the blindfold filter transmits source light beams having specific wavelength ranges which are transmitted through the design patterns respectively, and the blindfold filter absorbs light beams having wavelength ranges out of the specific wavelength ranges. Therefore, the blindfold filter is provided, whereby the design pattern can be illuminated and displayed when the light source is lit on, and the design patterns hardly visible to prevent deterioration of the aesthetics compared with a conventional technique when only an outer peripheral light beam exists while the light source is turned off.

### BACKGROUND OF THE INVENTION

1. Field of the Invention

The present invention relates to a display filter which displays plural design patterns at a display point in switching manner and a display module provided with the display filter.

2. Description of the Related Art

Conventionally there is a display device which displays plural designs at the same display position in the switching manner by switching light beams having different colors emitted from plural light sources. The display device is basically formed as follows (refer to, for example, Japanese Utility Model Application Laid-Open No. 61-171088).

As shown in FIG. 31, a display device 10 includes a red light source 1 which emits a red light beam, a green light source 2 which emits a green light beam, a red filter 3 which blocks the green light beam, and a green filter 4 which blocks the red light beam. The display device 10 is configured such that the light beams emitted from the light sources 1 and 2 are transmitted through the filters 3 and 4, respectively. Actually the red filter 3 and the green filter 4 are integrally formed into one filter. As shown in FIG. 32B, a transparent or opening circular design portion 3a is formed in the red filter 3, and a region 3b except for the circular design portion 3a is in red. As shown in FIG. 32C, a red X-shape design portion 4a is formed in the green filter 4, and a region 4b except for the X-shape design portion 4a is in green. As described above, because the red filter 3 and the green filter 4 are integrally formed into one filter, the circular design portion 3a and the X-shape design portion 4a are located at the same point as shown in FIG. 32A.

The conventional display device 10 performs the following display operation. When the red light source 1 is lit on, the red light beam is transmitted through both the red region 3b and the transparent or opening circular design portion 3a in the red filter 3, and the red light beam is blocked by the green region 4b and transmitted through the red X-shape design portion 4a in the green filter 4. As a result, the X-shape design portion 4a is illuminated and displayed in red when the red light source 1 is lit on. On the other hand, when the green light source 2 is lit on, the green light beam is blocked by the red region 3b and transmitted through the transparent or opening circular design portion 3a in the red filter 3, and the green light beam is transmitted through the green region 4b and blocked by the red X-shape design portion 4a in the green filter 4. As a result, the circular design portion 3a is illuminated and displayed in green when the green light source 2 is lit on. Thus, in the display device 10, the two designs can independently be displayed at the same point by switching the lighting of the light sources 1 and 2.

As described above, in the conventional display device 10, when one of the red light source 1 and the green light source 2 is lit on, the circular design portion 3a and the X-shape design portion 4a can independently be displayed. However, when both the red light source 1 and the green light source 2 are turned off, unfortunately both the circular design portion 3a and the X-shape design portion 4a are visible while overlapped with each other by action of an outer peripheral light beam around the display device 10 as shown in FIG. 32A. Although the display device 10 can be used as a manipulation unit such as a portable telephone, because the decreased power consumption is demanded in the battery-driven mobile device, usually the illumination light source for a manipulation button is turned off except for a required time. Accordingly, that the unnecessary design pattern is visible during the turn-off is a large drawback in the manipulation unit of the mobile device which gives a priority to aesthetics.

In order to solve the problem there is disclosed a technique of further providing a black smoke filter on the transmission side of the color filters 3 and 4 (refer to, for example, Japanese Patent No. 3160166). Although the plural design patterns becomes hardly visible by providing the smoke filter during the turn-off, the smoke filter evenly blocks the light beams having all the wavelength ranges, which causes a new problem in that luminance of transmission display of the design pattern is also lowered while the light source is lit on.

In view of the foregoing problems, an object of the invention is to provide a display filter, in which the plural design patterns are independently illuminated and displayed by switching the source light beams and the aesthetics is not lost during the turn-off of the source light beam, and a display module provided with the display filter.

### SUMMARY OF THE INVENTION

In accordance with a first aspect of the invention, a display filter includes plural design pattern filters which are overlapped with each other; and a blindfold filter which is disposed on a visibility side while overlapped with the plural design pattern filters, the visibility side being located across the plural design pattern filters from a light source, wherein the design pattern filter has a design pattern which transmits a source light beam having a specific wavelength range, the design pattern filter is an absorption type filter which absorbs the source light beam having the specific wavelength range in a basis material portion outside the design pattern, the design pattern filters have design patterns different from each other, and the design pattern filters absorb the source light beams having the specific wavelength ranges to display the different design patterns respectively, and the blindfold filter is a filter which prevents an outer peripheral light beam from causing the plural design patterns to become visible when the source light beam is turned off, the blindfold filter transmits the source light beam having the specific wavelength range transmitted through each design pattern, and the blindfold filter absorbs light beams having wavelength range out of each specific wavelength range.

Further, in the display filter of the invention, preferably the design pattern filters and the blindfold filter are integrally formed in one sheet material. Further, in the display filter of the invention, preferably the design pattern filter and the blindfold filter are integrally formed in one sheet material by ink printing.

Further, in the display filter of the invention, preferably the display filter further includes an achromatic filter which is disposed on he visibility side or a light source side of the blindfold filter, the achromatic filter including a display design pattern which becomes visible when the outer peripheral light beam exists while the source light beam is turned off.

Further, in the display filter of the invention, preferably the display design pattern is formed by performing ink printing to the blindfold filter.

Further, in the display filter of the invention, preferably the display design pattern in the achromatic filter is formed by performing ink printing or vacuum plating to a transparent or translucent sheet material.

Further, in the display filter of the invention, preferably the display design pattern in the achromatic filter is identical to one of the design patterns in the design pattern filter.

Further, in the display filter of the invention, preferably the specific wavelength ranges of the source light beams absorbed by the design pattern filters are different from each other, and the specific wavelength ranges are not overlapped with each other. Further, in the display filter of the invention, preferably the specific wavelength ranges of the source light beams absorbed by the design pattern filters are overlapped in a boundary region.

Further, in the display filter of the invention, preferably the design patterns formed in the design pattern filters are disposed at an identical point while overlapped with each other. Further, in the display filter of the invention, preferably the design patterns formed in the design pattern filters are disposed at positions different from each other while not overlapped with each other.

In accordance with a second embodiment of the invention, a display module includes the display filter as in any one of the first aspect; and a light source which emits a source light beam having a specific wavelength range, the source light beam having a specific wavelength range being absorbed by the design pattern filters included in the display filter.

Further, in the display module of the invention, preferably the plural light sources are provided, each light source emits a source light beam corresponding to a specific wavelength range absorbed by each design pattern filter, and the display module further includes a selector switch which switches the light source to be emitted, the selector switch displaying a design pattern in a design pattern filter corresponding to the source light beam emitted from the light source.

The display module according to the second aspect of the invention includes the plural design pattern filters and the blindfold filter, the blindfold filter is disposed on the visibility side opposite the light source, the blindfold filter transmits source light beams having the specific wavelength ranges transmitted through the design pattern, and the blindfold filter absorbs the light beams having the wavelength ranges out of the specific wavelength ranges. Therefore, when the source light beam is emitted from the light source to the display filter, the source light beam is transmitted through the design pattern drawn in the design pattern filter which absorbs the specific wavelength range possessed by the source light beam, and the source light beam is incident to the specific wavelength range. As described above, because the source light beams having the specific wavelength ranges transmitted through the design patterns are transmitted through the blindfold filter, the source light beam transmitted through the design pattern is transmitted through the blindfold filter. Accordingly, the design pattern drawn in the design pattern filter which absorbs the specific wavelength range possessed by the source light beam is visible, and the plural design patterns can independently be illuminated and displayed by switching the source light beam.

On the other hand, when the source light beam is turned off, the outer peripheral light beams is incident to the blindfold filter and reflected from the blindfold filter, and the outer peripheral light beams transmitted through the blindfold filter is incident to each design pattern filter and reflected from the design pattern filter. As described above, the source light beams having the specific wavelength ranges transmitted through the design patterns are transmitted through the blindfold filter, and the light beams having the wavelength ranges out of the specific wavelength ranges are absorbed by the blindfold filter. Because the light beam which is reflected by the design pattern filters and transmitted through the blindfold filter becomes the light beam having the wavelength range in which the specific wavelength ranges corresponding to the design pattern filters are synthesized, the color shading caused by the overlap of the design pattern filters can be reduced, and the visible color can be brought close to black (achromatic) by adding the blindfold filter to the plural design pattern filters. Accordingly, in the case where only the outer peripheral light beams exists while the source light beam does not exist, compared with the conventional technique, the design patterns formed in the design pattern filters can become hardly visible, and the deterioration of the aesthetics can be prevented in the display portion.

The design pattern filters and the blindfold filter are formed in the one sheet material, whereby the compact and friendly display filter can be formed.

The display design pattern possessed by the achromatic filter can be displayed by providing the achromatic filter when only the outer peripheral light beams exists while the source light beam does not exist.

The achromatic filter is formed in the blindfold filter by the printing, whereby the compact and friendly display filter can be formed. On the other hand, the achromatic filter is made of the transparent or translucent sheet material, whereby the achromatic filter can be attached and detached. The display design pattern possessed by the achromatic filter conforms to the design pattern possessed by one of the design pattern filters, so that luminance of the display design pattern is further enhanced by both the action of the source light beam and the action of the outer peripheral light beams when display design pattern is illuminated with the source light beam.

The display module according to the second aspect of the invention includes the display filter of the first aspect, so that the plural design patterns can independently be illuminated and displayed and the deterioration of the aesthetics can be prevented during turn-off of the source light beam.

### BRIEF DESCRIPTION OF THE DRAWINGS

FIG. 1 shows a sectional view of a display module according to a first embodiment of the invention;

FIG. 2 shows a perspective view of a display filter included in the display module of FIG. 1;

FIG. 3 shows a view for explaining that a design pattern becomes hardly visible by action of an example of a blindfold filter included in the display filter of FIG. 2;

FIG. 4 shows a view for explaining that the design pattern becomes hardly visible by action of another example of the blindfold filter included in the display filter of FIG. 2;

FIG. 5 shows a view for explaining a principle in which the design pattern included in the display filter of FIG. 2 is visible;

FIG. 6 shows a view in the case where the blindfold filter does not exist for the purpose of explanation that the design pattern becomes hardly visible by the blindfold filter of FIG. 2;

FIG. 7 shows a view for explaining that the design pattern becomes hardly visible by the blindfold filter of FIG. 2;

FIG. 8 shows a view in the case where the blindfold filter does not exist for the purpose of explanation that the design pattern is visible irrespective of the existence of the blindfold filter of FIG. 2;

FIG. 9 shows a view in the case where the blindfold filter is provided for the purpose of explanation that the design pattern is visible irrespective of the existence of the blindfold filter of FIG. 2;

FIG. 10 shows a state in which the design patterns included in the display filter of FIG. 2 are not overlapped but individually disposed;

FIG. 11 shows a graph of a wavelength range of a source light beam in each color LED which can be used as a light source included in the display module of FIG. 1;

FIG. 12 shows a graph of light-emitting characteristics of a red light source included in the display module of FIG. 1 and transmission characteristics of a blue design pattern filter;

FIG. 13 shows a graph of light-emitting characteristics of a blue light source included in the display module of FIG. 1 and transmission characteristics of a red design pattern filter;

FIG. 14 shows a graph of transmission characteristics and reflectance characteristics of the blue design pattern filter included in the display module of FIG. 1;

FIG. 15 shows a graph of transmission characteristics and reflectance characteristics of the red design pattern filter included in the display module of FIG. 1;

FIG. 16 shows a graph of light-emitting characteristics of the red and blue light sources included in the display module of FIG. 1, transmission characteristics of the blue and red design pattern filters, and transmission characteristics of the blindfold filter;

FIG. 17 shows a graph of transmission characteristics and reflectance characteristics of the blindfold filter included in the display module of FIG. 1;

FIG. 18 shows an example of near-ideal transmission characteristics of the blindfold filter included in the display module of FIG. 1;

FIG. 19 shows a sectional view of a specific configuration example of the display module shown in FIG. 1;

FIG. 20 shows a sectional view of a specific configuration example of the display module shown in FIG, 1;

FIG. 21 shows a sectional view of a specific configuration example of the display module shown in FIG. 1;

FIG. 22 shows a sectional view of a specific configuration example of the display module shown in FIG. 1;

FIG. 23 shows a sectional view of a specific configuration example of the display module shown in FIG. 1;

FIG. 24 shows a sectional view of a display module according to a second embodiment of the invention;

FIG. 25 shows a perspective view of a display filter included in the display module of FIG. 24;

FIG. 26 shows a view for explaining action of an achromatic filter included in the display filter of FIG. 24;

FIG. 27 shows a sectional view of a display module including another example of the display filter of FIG. 24;

FIG. 28 shows a perspective view of the display filter in another example of FIG. 27;

FIG. 29 shows a perspective view of a state in which the same display design pattern as the design pattern is formed in the achromatic filter in the display filters of FIGS. 24 and 27;

FIG. 30 shows a perspective view of a modification of the display filter shown in FIG. 24, and FIG. 30 shows the case in which the achromatic filter is disposed between the blindfold filter and the design pattern filter;

FIG. 31 shows a sectional view of a conventional display module; and

FIG. 32 shows a view for explaining an operation of a conventional display module.

### DETAILED DESCRIPTION OF THE PREFERRED EMBODIMENTS

A display filter and a display module provided with the display filter according to an embodiment of the invention will be described below with reference to the drawings. In the following drawings, the identical or similar component is designated by the same numeral. In each drawing, a hatching and a mesh design with dotted lines does not show a section but express various design pattern filters, blindfold filters, and achromatic filters. On the other hand, a hatching with solid lines shows a section of a structure.

### First Embodiment

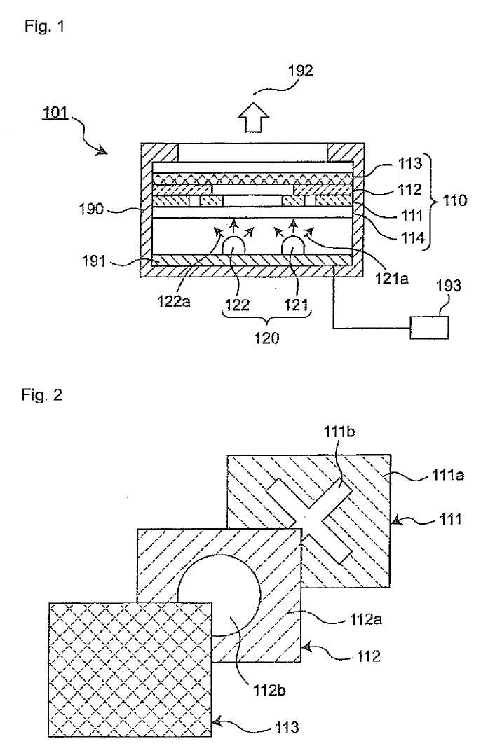

As shown in FIG. 1, a display module 101 of the first embodiment includes a display filter 110 and a light source 120 which are of a basic component, and the display module 101 has a configuration in which the display filter 110 is disposed in a chassis 190 while facing the light source 120 mounted on a circuit board 191. A light source drive circuit unit 193 which turns on and off the light source 120 and switches plural light sources can be connected to the circuit board 191. Therefore, in the display module 101, a source light beam emitted from the light source 120 is transmitted through the display filter 110, and a design pattern formed in the display filter 110 is visible on the visibility side 192, while the aesthetics of the display unit can be prevented from deteriorating during the turn-off of the light source 120. The description will be given in detail.

The light source 120 has a structure in which light beams having plural colors can be emitted. In the first embodiment, the light source 120 includes a blue light source 121 which emits a light beam having a blue wavelength range and a red light source 122 which emits a light beam having a red wavelength range. Thus, it is necessary that the light source 120 emits a light beam having a specific wavelength range. For example, preferably LED (Light-Emitting Diode), LD (Laser Diode), and EL (ElectroLuminescence) are used as the light source 120. In the first embodiment, LED which emits a source light beam 121a having a specific wavelength range of 465±20 nm is used as the blue light source 121, and LED which emits a source light beam 122a having a specific wavelength range of 630±15 nm is used as the red light source 122. Alternatively, a source light beam 122a having a specific wavelength range of 605±15 nm may be used as the red light source 122.

As used herein, “specific wavelength range” shall means a concept including not only a wavelength band having a predetermined width as described above, but also only one wavelength of, for example, 465 nm included in the wavelength band.

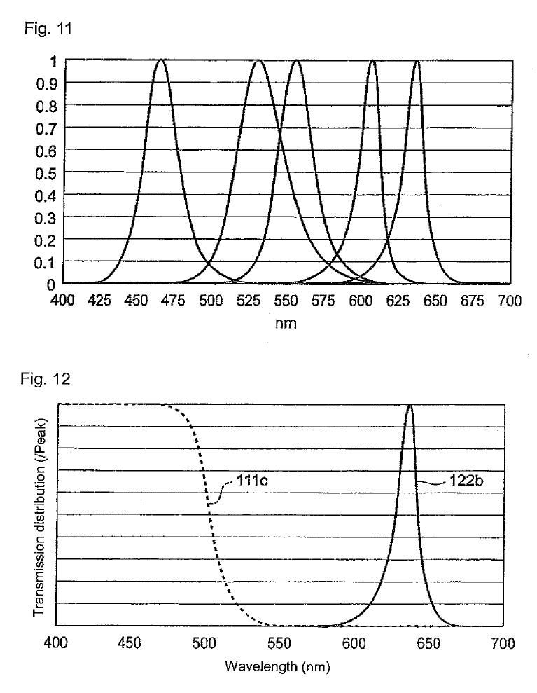

The light source 120 is not limited to the blue light source 121 and the red light source 122. As shown in FIG. 11, already-existing LEDs and the like which emit light beams having green, yellow green, yellow, and orange colors can be used as the light source 120, and a light source having a color which will be produced in near future can also be used as the light source 120. Although the light source 120 has the blue and red colors in the first embodiment, the light source 120 may have a configuration in which light beams having at least three colors are emitted.

The specific wavelength ranges are not overlapped with each other in the blue light source 121 and red light source 122 used in the first embodiment. However, two source light beams whose specific wavelength ranges are overlapped with each other in a boundary region thereof can also be used in the case where the two source light beams having the specific wavelength ranges are emitted from the light source 120. Furthermore, source light beams in which at least two specific wavelength ranges are overlapped with each other in the boundary region thereof can also be used in the case where the source light beams having at least three specific wavelength ranges are emitted from the light source 120.

In the first embodiment, the two individual source light beams having the different colors are provided as the light source 120 because of the simple configuration. Alternatively, the light source 120 may includes one light source and plural color filters such that the color can be changed by selecting the color filter.

As shown in FIGS. 1 and 2, the display filter 110 of the first embodiment includes a blue design pattern filter 111, a red design pattern filter 112, a blindfold filter 113, and a diffuser panel 114. The filters are formed into the same shape, and the filters are disposed while overlapped with one another. The diffuser panel 114, the blue design pattern filter 111, the red design pattern filter 112, and the blindfold filter 113 are disposed in this order from the side of the light source 120 toward the visibility side 192, and the blindfold filter 113 is disposed closest to the visibility side 192. In order to protect the display filter 110 having the above-described configuration, usually a transparent cover is disposed on the visibility side 192 of the blindfold filter 113. The blue design pattern filter 111 and the red design pattern filter 112 are not limited to the above-described disposition order, but the disposition order of the blue design pattern filter 111 and the red design pattern filter 112 may be exchanged.

In the drawings and following description, for the sake of easy drawing and understanding, it is assumed that the blue design pattern filter 111, the red design pattern filter 112, and the blindfold filter 113 are made of individual sheet materials. However, in the first and second embodiments, the blue design pattern filter 111, the red design pattern filter 112, and the blindfold filter 113 are integrally formed by an ink printing process in which one sheet material is used. Obviously, as described later, the blue design pattern filter 111, the red design pattern filter 112, and the blindfold filter 113 made of the individual sheet materials may be overlapped with one another to integrally form the display filter 110 by bonding. Alternatively, the blue design pattern filter 111, the red design pattern filter 112, and the blindfold filter 113 may integrally be formed by performing a plating process to one sheet material.

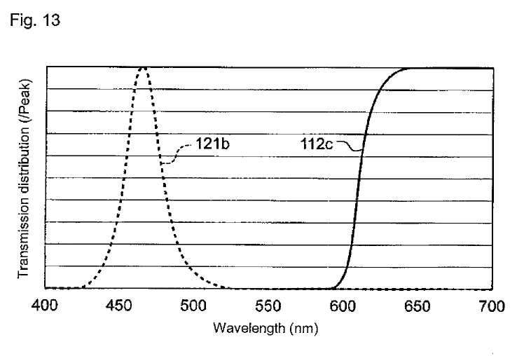

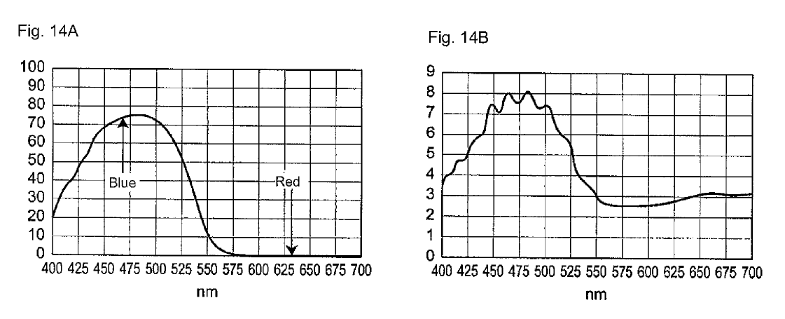

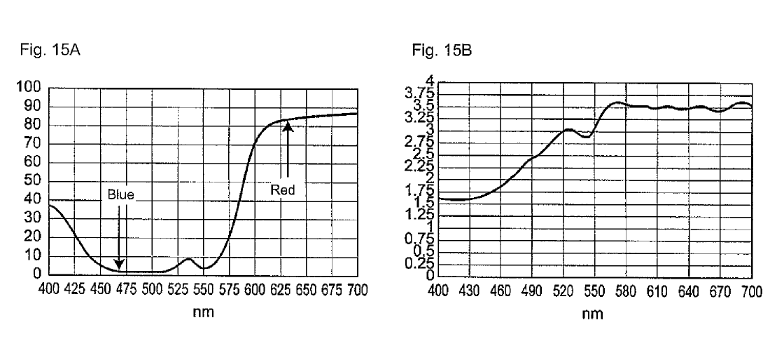

The design pattern filters 111 and 112 constituting the display filter 110 are an absorption type filter which absorbs the source light beam having the specific wavelength range emitted from the light source 120. In the first embodiment, the blue design pattern filter 111 which absorbs the light beam having the specific wavelength range in the red source light beam 122a as shown in FIGS. 12 and 14 and the red design pattern filter 112 which absorbs the light having the specific wavelength range in the blue source light beam 121a as shown in FIGS. 13 and 15 are provided, because the blue light source 121 which emits the source light beam 121a having the specific wavelength range and the red light source 122 which emits the source light beam 122a having the specific wavelength range are included as the light source 120. Thus, the plural design pattern filters are provided according to the source light beams having the plural colors emitted from the placed light source 120, that is, the plural specific wavelength ranges.

FIG. 12 shows light-emitting characteristics of the red light source 122, that is, transmission characteristics 111c (dotted line) of the light wavelength in the blue design pattern filter 111 for a specific wavelength range 122b (solid line). FIG. 13 shows light-emitting characteristics of the blue light source 121, that is, transmission characteristics 112c (solid line) of the light wavelength in the red design pattern filter 112 for a specific wavelength range 121b (dotted line). The transmission characteristics 111c in the blue design pattern filter 111 shown in FIG. 12 and the transmission characteristics 112c in the red design pattern filter 112 show ideal transmission characteristics in the design pattern filters 111 and 112, respectively. The characteristics relatively close to the ideal transmission characteristics can be obtained when basis material portions 111a and 112a of the design pattern filters 111 and 112 are formed by the plating process.

FIGS. 14A and 14B show transmittance and reflectance for the light wavelength in the blue design pattern filter 111 when the basis material portion 111a of the blue design pattern filter 111 is formed by the ink printing. FIGS. 15A and 15B show transmittance and reflectance for the light wavelength in the red design pattern filter 112 when the basis material portion 112a of the red design pattern filter 112 is formed by the ink printing.

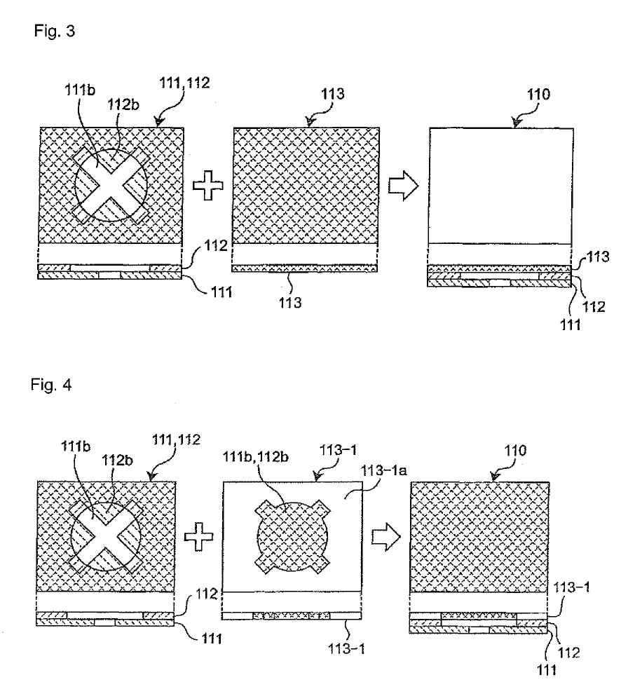

The design patterns are formed in the design pattern filters 111 and 112, respectively. Each of the design patterns is visible when one of the blue light source 121 and the red light source 122 is lit on. That is, in the first embodiment, as shown in FIG. 2, the transparent or opening design pattern 111b having an X-shape is formed for the blue basis material portion 111a in the blue design pattern filter 111, and the transparent or opening design pattern 112b having a circular shape is formed for the red basis material portion 112a in the red design pattern filter 112. In the first embodiment, as shown in FIG. 3, the design patterns 111b and 112b are disposed while overlapped with each other. As shown in FIG. 10, the design patterns 111b and 112b can be disposed at individual positions, for example, positions adjacent to each other without overlapping the design patterns 111b and 112b. In such cases, the design patterns having the same shape are formed, and orientations of the design patterns can be changed such that the shapes of “|” and are “-” obtained.

Accordingly, as is clear from the characteristics shown in FIGS. 12 to 15, the design pattern filters 111 and 112 act as follows. When the red light source 122 is lit on, the red source light beam 122a is transmitted through the transparent or opening design pattern 111b having the X-shape to be incident to the red design pattern filter 112 while absorbed by the basis material portion 111a of the blue design pattern filter 111. In the red design pattern filter 112, the red source light beam 122a is transmitted through the basis material portion 112a and the transparent or opening circular design pattern 112b. Therefore, the design pattern 111b having the X-shape in the blue design pattern filter 111 is displayed in red when the red light source 122 is lit on. When the blue light source 121 is lit on, the blue source light beam 121a is transmitted through the basis material portion 111a of the blue design pattern filter 111 and the transparent or opening design pattern 111b to be incident to the red design pattern filter 112, that is, the blue source light beam 121a is transmitted through the basis material portion 111a of the blue design pattern filter 111 to be incident to the red design pattern filter 112 without displaying the design pattern 111b having the X-shape. In the red design pattern filter 112, the blue source light beam 121a is absorbed in the basis material portion 112a, and the blue source light beam 121a is transmitted through the transparent or opening circular design pattern 112b. Therefore, the circular design pattern 112b in the red design pattern filter 112 is displayed in blue when the blue light source 121 is lit on.

The blindfold filter 113 which is of one of the features of the first embodiment will be described below. The blindfold filter 113 is a filter which prevents the plural design patterns 111b and 112b from being visually recognized only by an outer peripheral light beam when the source light beams 121a and 122a from the light source 120 are in the turn-off state. As shown in FIG. 1, the blindfold filter 113 is disposed on the visibility side 192 while overlapped with the design pattern filters 111 and 112. The visibility side 192 is located across the design pattern filters 111 and 112 from the light source 120. The blindfold filter 113 transmits the source light beams 122a and 121a having the specific wavelength ranges transmitted through the design patterns 111b and 112b, and the blindfold filter 113 absorbs the light having the wavelength range out of the specific wavelength ranges to decrease a reflected light component.

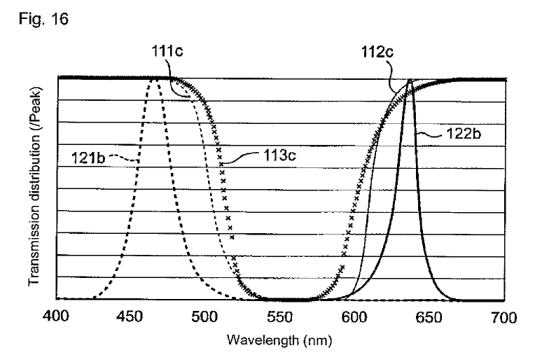

The specific description will be given with reference to FIGS. 16 and 17. FIG. 16 shows light-emitting characteristics 111c of the blue design pattern filter 111 for the light-emitting characteristics 122b of the red light source 122 shown in FIG. 12, light-wavelength transmission characteristics 112c of the red design pattern filter 112 for the light-emitting characteristics 121b of the blue light source 121 shown in FIG. 13, and light-wavelength transmission characteristics 113c of the blindfold filter 113. The light-wavelength transmission characteristics 113c show ideal transmission characteristics, and characteristics close to the ideal transmission characteristics can be obtained when the blindfold filter 113 is formed by the plating process. FIGS. 17A and 17B shows transmittance and reflectance for the light wavelength when the blindfold filter 113 is formed by ink printing.

As is clear from FIGS. 16 and 17, the blindfold filter 113 substantially completely transmits the source light beam 121a having the specific wavelength range 121b of, for example, 465±20 nm emitted from the blue light source 121 and the source light beam 122a having the specific wavelength range 122b of, for example, 630±15 nm emitted from the red light source 122. On the other hand, the blindfold filter 113 substantially completely absorbs the light beam having the wavelength ranges except for the specific wavelength ranges, that is, the light beam having the wavelength range around about 560 nm. In the case where the blindfold filter 113, the blue design pattern filter 111, and the red design pattern filter 112 are formed by the ink printing, a relationship of transmittance+reflectance+absorptance=1 holds theoretically for the transmittances, the reflectances and the absorptances of the filters. There is also a correlation between the transmittance and the reflectance for pigment used in the ink printing. That is, the reflectance is increased with increasing transmittance. Because the blindfold filter 113, the blue design pattern filter 111, and the red design pattern filter 112 have the above-described absorption and transmission characteristics of the light wavelength, the color in which the blue and red of the source light beams 121a and 122a are synthesized, that is, magenta is obtained when the blindfold filter 113 is expressed in color.

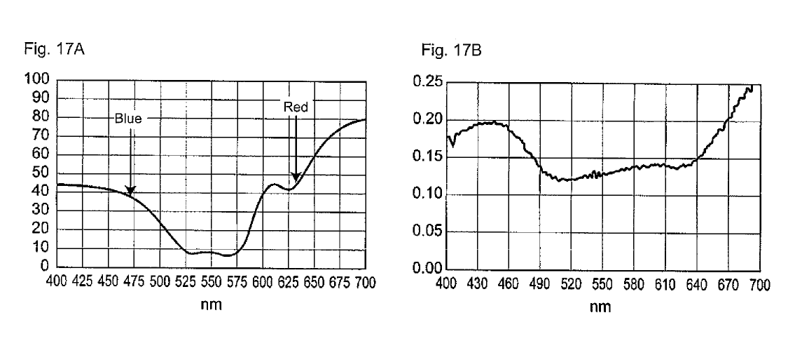

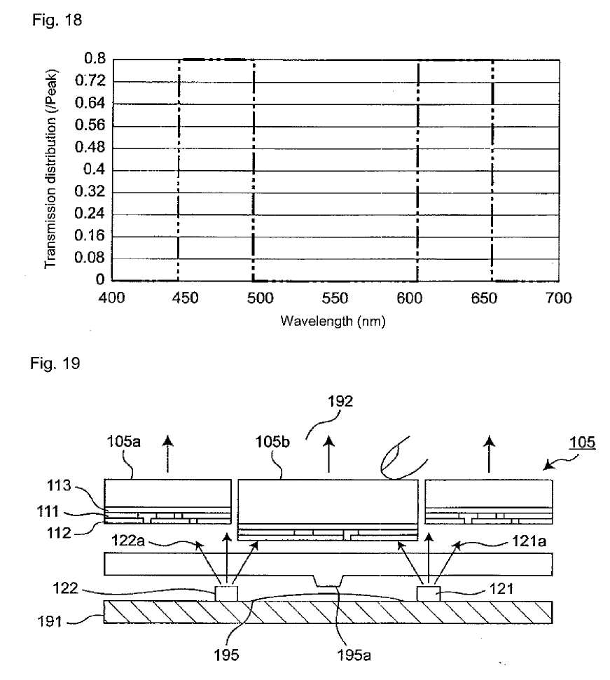

The blindfold filter 113 of the first embodiment has the absorption and transmission characteristics of the light wavelength in which the transmittance is substantially completely 100% for the source light beams having the specific wavelength ranges while the absorptance is substantially completely 0% for the source light beams out of the specific wavelength ranges. Preferably the blindfold filter 113 has rectangular transmission characteristics shown in FIG. 18 which is close to that of the ideal blindfold filter 113 in order that the blindfold filter 113 fulfills the following function as the blindfold filter 113 for the blue source light beam 121a having the specific wavelength range 121b and the red source light beam 122a having the specific wavelength range 122b like the first embodiment. On the other hand, the transmittance of the blindfold filter 113 is lowered as much as possible, for example, 10% or less in order that the plural design patterns 111b and 112b cannot be visually recognized only by the outer peripheral light beam when the source light beams 121a and 122a from the light source 120 are in the turn-off state. However, in the low transmittance, the source light beam 121a and 122a cannot be transmitted through the blindfold filter 113 when the light source 120 is lit on, and the design patterns 111b and 112b cannot be visually recognized. In the present state of things, as shown in FIG. 17A, the transmittance is about 40% for the blue and red specific wavelength ranges in the case where the blindfold filter 113 is formed by the ink printing, and the blindfold filter 113 can sufficiently fulfill the function if the transmittance is about 40%. Accordingly, in order that the blindfold filter 113 fulfills the following function, the blindfold filter 113 has the transmittance of about 40%, preferably 70% or more, more preferably 80% or more for the source light beams having the specific wavelength ranges and the absorptance of 95% or more for the light beams having the wavelength ranges out of the specific wavelength ranges.

In the case where source light beams having two or at least three wavelength ranges except for the blue source light beam 121a and the red source light beam 122a are used, the blindfold filter 113 has the transmittance and absorptance of the source light beam, whereby the blindfold filter 113 fulfills the following function irrespective of the source light beams having the specific wavelength ranges emitted from the plural light sources 120.

As described above, because the blindfold filter 113 is disposed closest to the visibility side 192 with respect to the design pattern filters 111 and 112, the light beam outgoing from the design pattern filter 112 is incident to the blindfold filter 113. On the other hand, because the blindfold filter 113 has the above-described transmission and absorption characteristics of the light wavelength, the blue circular design pattern 112b which is expressed by the red design pattern filter 112 when the blue light source 121 is lit on and the red X-shape design pattern 111b which is expressed by the blue design pattern filter 111 when the red light source 122 is lit on are directly visible without lowering the transmittances. The blindfold filter 113 differs largely from the conventional so-called smoke filter in the characteristics.

As shown in FIG. 3, the blindfold filter 113 may be formed so as to have the absorption and transmission characteristics of the light wavelength over the surface thereof. As shown in FIG. 4, a blindfold filter 113-1 may be formed so as to have the absorption and transmission characteristics of the light wavelength for a portions corresponding to the design patterns 111b and 112b and to be transparent for a region 113-1a except for the design patterns 111b and 112b.

The blindfold filter 113 is disposed closest to the visibility side 192, whereby the blindfold filter 113 fulfills the following function. When the source light beam does not exist because the blue light source 121 and the red light source 122 are turned off, the outer peripheral light beam including all the wavelengths are incident to the blindfold filter 113, the outer peripheral light beam is reflected from a surface of the blindfold filter 113, the outer peripheral light beam transmitted through the blindfold filter 113 is incident to the design pattern filters 111 and 112, or the outer peripheral light beam is reflected from surfaces of the design pattern filters 111 and 112. The blindfold filter 113 transmits the source light beams 122a and 121a having the specific wavelength ranges respectively transmitted through the design patterns 111b and 112b, and the blindfold filter 113 absorbs the light beam having the wavelength ranges out of the specific wavelength ranges. The light beam which is reflected from the design pattern filters 111 and 112 and transmitted through the blindfold filter 113 becomes the light beam having the wavelength range in which the specific wavelength ranges corresponding to the design pattern filters 111 and 112are synthesized, so that the color shading caused by overlapping the design pattern filters 111 and 112 can be decreased, and the visible color can brought close to black (achromatic) by adding the blindfold filter 113 to the design pattern filters 111 and 112. Accordingly, when only the outer peripheral light beam exists while the blue light source 121 and the red light source 122 are in the turn-off state, the design patterns 111b and 112b formed in the design pattern filters 111 and 112 can become more hardly visible to prevent the deterioration of the aesthetics of the display portion compared with the conventional technique.

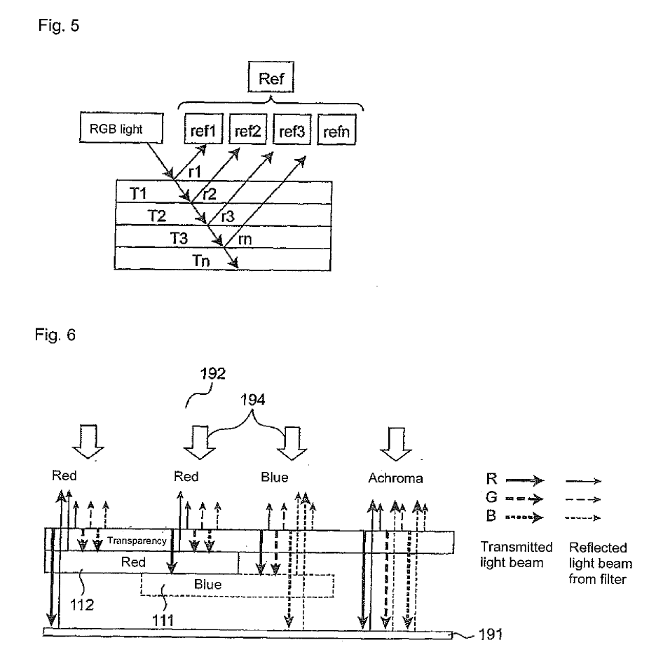

That the design patterns 111b and 112b become more hardly visible compared with the conventional technique will be described in detail with reference to FIGS. 5 to 9. In the case where only the outer peripheral light beam exists while the blue light source 121 and the red light source 122 are in the turn-off state, the design patterns 111b and 112b formed in the design pattern filters 111 and 112 is lightly visible when the blindfold filter 113 is not provided. The principle will be described below. In the case where only the outer peripheral light beam exists while the blue light source 121 and the red light source 122 are in the turn-off state, the display visually recognized by the laminated layers, that is, the reflected light is visible while the light beams transmitted through and reflected from the layers are synthesized as shown in FIG. 5. This synthesis of red (R), blue (B), and green (G) components can be considered from visual perception characteristics, the reflected light (Ref) which is visible in the synthesized manner is obtained by adding the reflected lights (ref1 to refn) which are transmitted through and reflected from the layers, and the reflected light (Ref) can be expressed by the following equation.

$$\begin{matrix}Ref = ref 1 + ref 2 + ref 3 + … + refn \\ = ( r 1 ) + ( T 1 * T 1 * r 2 ) + ( T 1 * T 2 * T 1 * T 2 * r 3 ) + … + \\ ( T 1 * T 1 * T 2 * T 2 * … Tn - 1 * Tn - 1 * rn )\end{matrix}$$

where r: reflectance (rn: reflectance of n-th layer) and T: transmittance (Tn: transmittance of n-th layer)

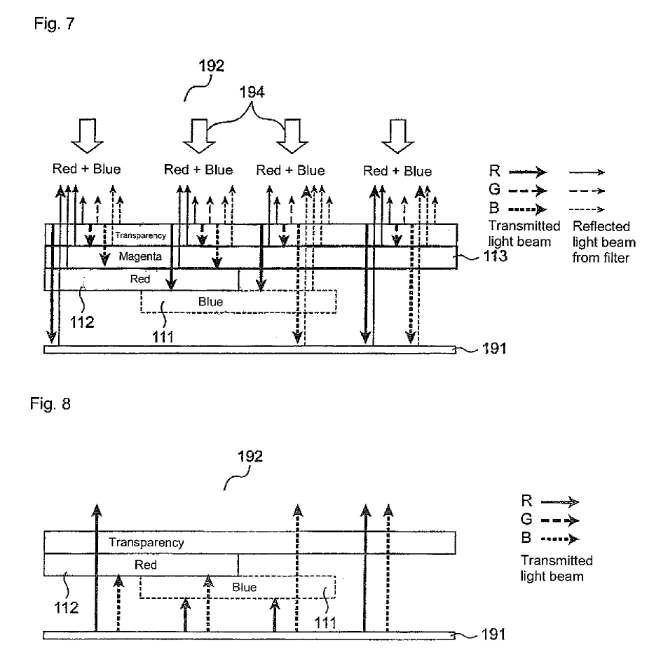

Based on the principle, FIG. 6 shows the state in which the outer peripheral light beam 194 acts on the blue design pattern filter 111 and the red design pattern filter 112 when the blindfold filter 113 does not exist, and FIG. 7 shows the state in which the outer peripheral light beam 194 acts on the blue design pattern filter 111 and the red design pattern filter 112 when the blindfold filter 113 is provided.

As shown in FIG. 6, the outer peripheral light beam 194 having the RGB components acts on a magenta portion where the red design pattern filter 112, the blue design pattern filter 111, the red design pattern filter 112, and the blue design pattern filter 111 are overlapped with one another and an achromatic and transparent portion. Therefore, the light beam having the red wavelength range is mainly supplied from the red design pattern filter 112 and the magenta portion onto the visibility side 192, and the light beam having the blue wavelength range is mainly supplied from blue design pattern filter 111 onto the visibility side 192, the light beams having the red, green, and blue wavelength ranges are supplied from the achromatic and transparent portion onto the visibility side 192.

On the other hand, as shown in FIG. 7, in the display filter 110 of the first embodiment having the configuration in which the blindfold filter 113 is disposed on the visibility side 192, the outer peripheral light beam 194 having the RGB component is incident to the display filter 110 to generate the following action. That is, because the blindfold filter 113 absorbs the light beams having the green wavelength range as described above, the light beam having the blue wavelength range and the light beam having the red wavelength range are supplied from the blindfold filter 113 onto the visibility side 192. In the red design pattern filter 112, the light beam having the green wavelength range is substantially absorbed by the blindfold filter 113 and does not reach the red design pattern filter 112, and the light beam having the blue wavelength range is absorbed by the red design pattern filter 112 while transmitted through the blindfold filter 113. Therefore, the light beam having the red wavelength range is transmitted through the blindfold filter 113 and supplied from the red design pattern filter 11 2, and the light beams having the blue and red wavelength ranges reflected from the surface of the blindfold filter 113 are supplied onto the visibility side 192. In the magenta portion, the light beam having the red wavelength range which is reflected from the surface of the red design pattern filter 112 and transmitted through the blindfold filter 113 and the light beams having the blue and red wavelength ranges which are reflected from the surface of the blindfold filter 113 are supplied onto the visibility side 192. In the blue design pattern filter 111, the light beam having the blue wavelength range which is reflected from the surface of the blue design pattern filter 111 and transmitted through the blindfold filter 113 and the light beams having the blue and red wavelength ranges which is reflected from the surface of the blindfold filter 113 are supplied onto the visibility side 192.

Thus, in the display filter 110 of the first embodiment having the configuration in which the blindfold filter 113 is disposed, the wavelength range of the light beam supplied onto the visibility side 192 by the outer peripheral light beam 194 becomes the blue and red wavelength ranges in each of the red design pattern filter 112, the magenta portion, the blue design pattern filter 111, and the transparent portion. Accordingly, the color shading is hardly recognized on the visibility side 192. That is, compared with the conventional technique, the design patterns 111b and 112b can become more hardly visible when the light source 120 is turned off.

In the case where a color filter material has light absorption characteristics, magenta+blue+red is obtained and brought close to black by a subtractive color process. Therefore, in the first embodiment, the colors of the magenta blindfold filter 113, blue design pattern filter 111, and red design pattern filter 112 can be mixed together and brought close to black (achromatic). From this standpoint, in the configuration of the first embodiment, the blindfold filter 113 is provided, and the design pattern 111b and 11 2b can become more hardly visible when the light source 120 is turned off compared with the conventional technique. Y (yellow)+C (cyan)+M (magenta) is desirable to obtain the ideal black. Therefore, the light source 120, the design pattern filter, and the blindfold filter are formed so as to have the wavelength ranges of the light beams having the combination for obtaining the ideal black, so that the design pattern 111b and 112b cannot substantially visibly recognized when the light source 120 is turned off.

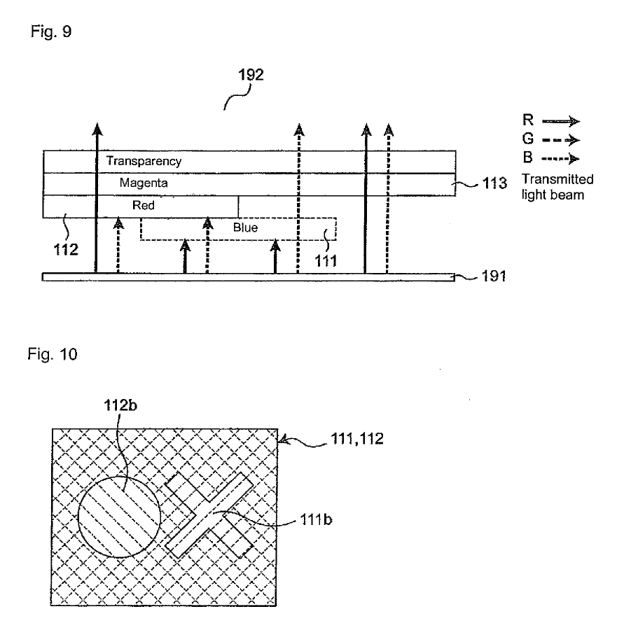

Even in the configuration in which the blindfold filter 113 is provided, when the blue light source 121 and the red light source 122 are lit on, the blue source light beam 121a and the red source light beam 122a can be transmitted through the blindfold filter 113 to reach the visibility side 192 as shown in FIG. 9. FIG. 8 shows the case in which the blindfold filter 113 is not provided. In FIG. 8, the blue source light beam 121a and the red source light beam 122a reach the visibility side 192.

As described above, in the display filter 110 of the first embodiment, the design pattern drawn in the design pattern filter which absorbs the specific wavelength range of the source light beam can be transmitted, illuminated, and displayed when the light source 120 is lit on. On the other hand, when only the outer peripheral light beam 194 is incident to the blindfold filter 113 and the plural design pattern filters 111 and 112 while the light source 120 is turned off, the blindfold filter 113 causes the design patterns 111b and 112b formed in the design pattern filters 111 and 112 to be able to become more hardly visible compared with the conventional technique, and the deterioration of the aesthetics can be prevented in the display portion.

In the first embodiment, as described above, the blue design pattern filter 111, the red design pattern filter 112, and the magenta blindfold filter 113 are provided for the blue source light beam 121a and red source light beam 122a emitted from the light source 120. Alternatively, in the case where the blue source light beam 121a and the red source light beam 122a are used, the red design pattern filter 112, the green design pattern filter, and a yellow blindfold filter may be used, or the blue design pattern filter 111, the green design pattern filter, and a cyan blindfold filter may be used.

An operation of the display module 101 having the display filter 110 will be described. When the blue light source 121 is lit on by the light source drive circuit unit 193, the blue source light beam 121a transmitted through the circular design pattern 112b formed in the red design pattern filter 112 is further transmitted through the blindfold filter 113 and reaches the visibility side 192. Therefore, when the blue light source 121 is lit on, the blue circular design pattern 112b is visible. When the red light source 122 is lit on, the red source light beam 122a transmitted through the X-shape design pattern 111b formed in the blue design pattern filter 111 is further transmitted through the blindfold filter 113 and reaches the visibility side 192. Therefore, when the red light source 122 is lit on, the red X-shape design pattern 111b is visible. Accordingly, the plural source light beams having the specific wavelength ranges emitted from the light source 120 are switched by the light source drive circuit unit 193, whereby the display module 101 can independently transmit, illuminate, and display the design patterns 112b and 111b drawn in the design pattern filters 112 and 111 which absorbs the specific wavelength ranges of the source light beams 121a and 122a.

On the other hand, when only the outer peripheral light beam 194 exists while the blue light source 121 and the red light source 122 are turned off, the blindfold filter 113 causes the design patterns 111b and 112b formed in the design pattern filters 111 and 112 to be able to become more hardly visible compared with the conventional technique, and the deterioration of the aesthetics can be prevented.

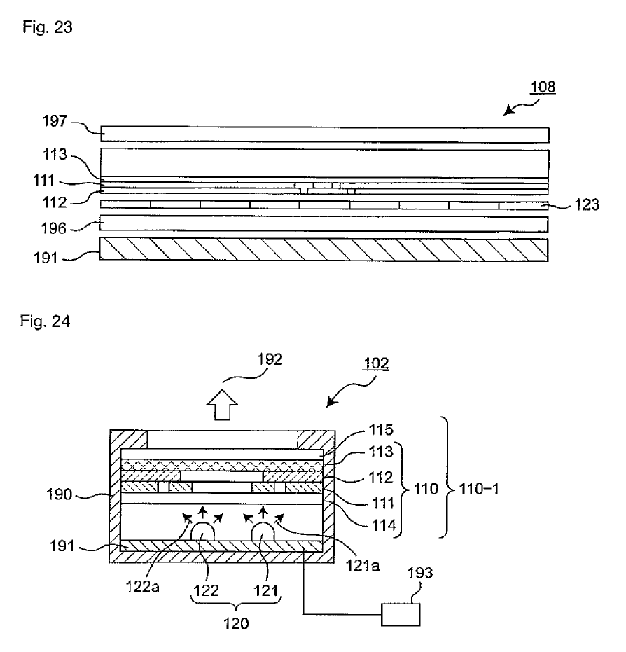

FIGS. 19 to 23 show specific configuration examples of the display module including the display filter 110. FIGS. 19 to 23 schematically show a part of a ten-key portion of a portable telephone. The layout of the components such as the light source and the number of components are not limited to the configurations of FIGS. 19 to 23. The light source drive circuit unit 193 of FIG. 1 is not shown in FIGS. 19 and 23.

FIG. 19 a part of a display module 105 including the light source 120 of LED, the blue light source 121, the red light source 122, and a dome switch 195. In the display module 105, the display filter 110 is formed in the transparent chassis portion 105a by the printing process, the design patterns 112b and 111b are displayed in a movable portion provided in a chassis portion 105a according to the lighting of the blue light source 121 or the red light source 122. The design patterns 112b and 111b is visually recognized to press the movable portion 105b, thereby activating the dome switch 195 through a presser 195a provided in a transparent elastic material such as silicone rubber.

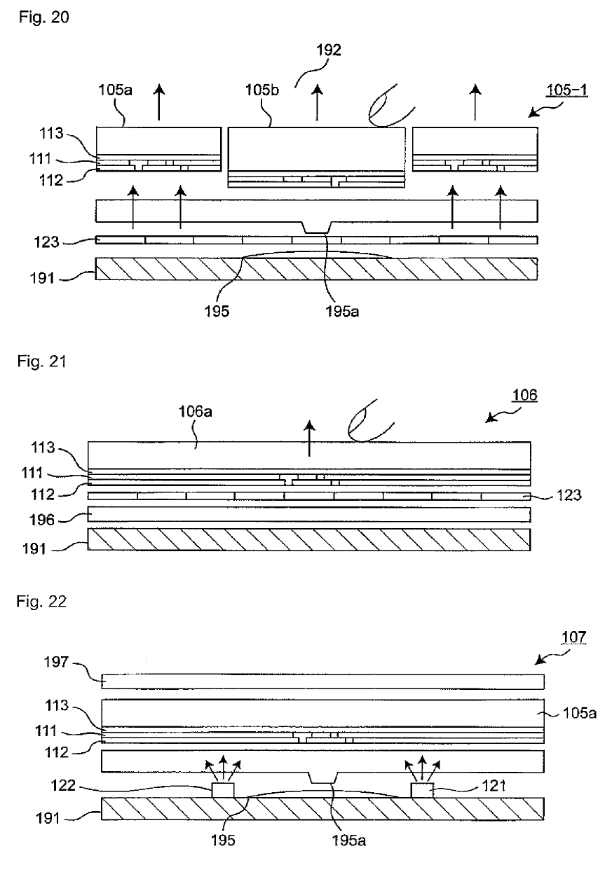

FIG. 20 shows a display module 105-1 in which blue and red ELs 123 are used as the light source instead of LED in the display module 105 of FIG. 19. The operation of the display module 105-1 is identical to that of the display module 105.

FIG. 21 shows a part of the display module 106 including light source 120 which is of EL 123 and a touch sensor 196. EL 123 has the blue light source and the red light source. In the display module 106, the display filter 110 is formed in the transparent chassis portion 106a by the printing process, and the design patterns 112b and 111b are displayed in the chassis portion 106a according to the lighting of the blue light source or the red light source. The design patterns 112b and 111b are visibly recognized to contact the chassis portion 106a, thereby activating the touch sensor 196.

FIG. 22 shows a display module 107 having a configuration in which a display module 107 is added to the display module 105 of FIG. 19. In the display module 107, when the transparent electronic paper 197 is formed, the design patterns 112b and 111b displayed in the chassis portion 105a are visible according to the lighting of the blue light source 121 or red light source 122.

FIG. 23 shows a display module 108 having a configuration in which the electronic paper 197 is added to the display module 106 of FIG. 21. Similarly to the display module 107, in the display module 108, the design patterns 112b and 111b are visible when the transparent electronic paper 197.

### Second Embodiment

FIG. 24 shows a display module 102 according to a second embodiment of the invention. The display module 102 differs from the display module 101 of the first embodiment in that display filter 110 included in the display module 101 is replaced for a display filter 110-1. Because other configurations of the display module 102 are similar to those of the display module 101, only the display filter 110-1 is described, and description is omitted for other components. In the display filter 110-1, the same component as the display module 101 of the first embodiment is designated by the same numeral, and the description is omitted.

In the display module 102 of the second embodiment, the source light beams 121a and 122a emitted from the light source 120 are transmitted from the display filter 110-1, whereby the design patterns 112b and 111b included in the display filter 110-1 is visible on the visibility side 192. Additionally, in the display module 102 of the second embodiment, the following display design pattern is visible by the outer peripheral light beam 194 when the light source 120 is turned off. The detailed description will be given below.

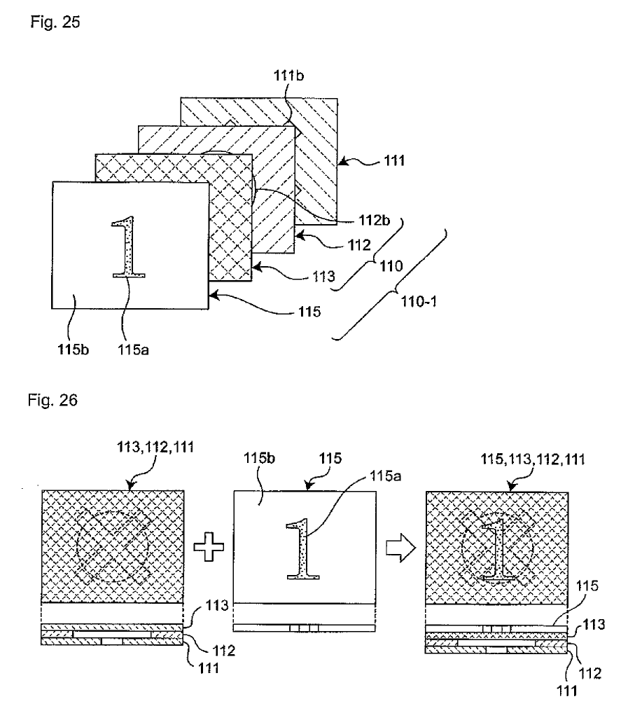

As shown in FIGS. 24 and 25, the display filter 110-1 includes the blue design pattern filter 111, the red design pattern filter 112, the blindfold filter 113, described in the first embodiment, and an achromatic filter 115 which is of one of the features in the second embodiment. In the second embodiment, the display filter 110-1 also includes the diffuser panel 114.

The achromatic filter 115 has the same shape as the design pattern filters 111 and 112 and the blindfold filter 113. The achromatic filter 115 is disposed while overlapped with the design pattern filters 111 and 112 and the blindfold filter 113, and the achromatic filter 115 is disposed on the visibility side 192 of the blindfold filter 113. A display design pattern 115a is formed in the achromatic filter 115, and the display design pattern 115a becomes visible by the outer peripheral light beam 194 when only the outer peripheral light beam 194 acts on the display filter 110-1 while the light source 120 is turned off. In the second embodiment, as shown in FIGS. 25 and 26, because the achromatic filter 115 is disposed on the blindfold filter 113 of the display filter 110, the display design pattern 115a is disposed while overlapped with the design patterns 111a and 112a.

In producing the achromatic filter 115, a transparent or translucent sheet material is used as a base material, a basis material portion 115b is made of a material in which at least one of a reflectance, and an absorptance, and a light diffusion difference is different from that of the display design pattern 115a by printing or vacuum plating. For example, the display design pattern 115a is made of a material having the high reflectance, and the basis material portion 115b is made of a material having the high absorptance.

In the achromatic filter 115 produced in the above-described way, when the achromatic filter 115 is illuminated with the outer peripheral light beam 194, a portion from which the outer peripheral light beam 194 is reflected is viewed in white and a portion where the outer peripheral light beam 194 is highly absorbed is viewed in black. Therefore, when only the outer peripheral light beam 194 acts while the light source 120 is turned off, the display filter 110-1 including the achromatic filter 115 causes the design patterns 111b and 112b to become hardly visible, and the display filter 110-1 causes the display design pattern 115a to become visible while the display design pattern 115a is in the state different from the basis material portion 115b. That is, the display design pattern 115a is expressed during the turn-off of the light source 120.

While the light source 120 emits the light, in order to prevent the generation of the uneven display caused by the obstruction of the display design pattern 115a in the design patterns 111b and 112b, preferably the display design pattern 115a is equalized or substantially equalized to the basis material portion 115b in the transmittance. As described above, in the achromatic filter 115, the display design pattern 115a is made of the material having the high reflectance, for example, the material having the reflectance of several percent, and the basis material portion 115b is made of the material having the high absorptance. However, the reflection of the display design pattern 115a heavily depends on illuminance of the outer peripheral light beam. This makes the decision of the reflectance of the display design pattern 115a very difficult when the display filter 110-1 is adopted in the mobile device such as the portable telephone used indoor and outdoor. When the reflectance of the display design pattern 115a is excessively enhanced in order to display the display design pattern 115a only with the indoor outer peripheral light beam while the light source 120 is turned off, unfortunately the display design pattern 115a is expressed by the light beam of the light source 120 when the light source 120 is lit on. On the contrary, when the reflectance of the display design pattern 115a is excessively lowered according to the outdoor outer peripheral light beam in order to prevent the problem, the display design pattern 115a cannot be expressed indoor in turning off the light source 120. Accordingly, actually it is necessary that the reflectance of the display design pattern 115a, the absorptance of the basis material portion 115b, the display design pattern 115a, and the transmittance of the basis material portion 115b be finely adjusted.

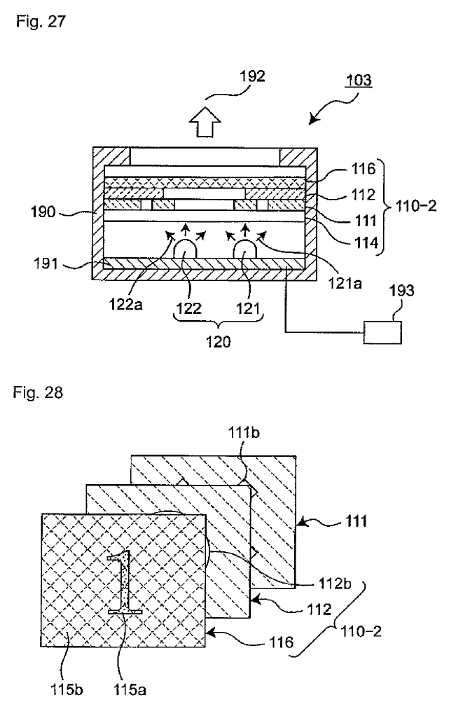

In the second embodiment, the achromatic filter 115 is formed by the component which is different from the display filter 110 including the design pattern filter 111 and 112 and the blindfold filter 113. Alternatively, as shown in FIGS. 27 and 28, the display design pattern 115a may be formed in the blindfold filter. That is, in FIGS. 27 and 28, a blindfold filter 116 has both the functions of the blindfold filter 113 and achromatic filter 115. The display design pattern 115a is formed on the visibility side 192 of the blindfold filter 116. A display filter 110-2 includes the blindfold filter 116, and a display module 103 includes the display filter 110-2. In the display filter 110-2, the same action and effect as the display filter 110-1 can also be obtained.

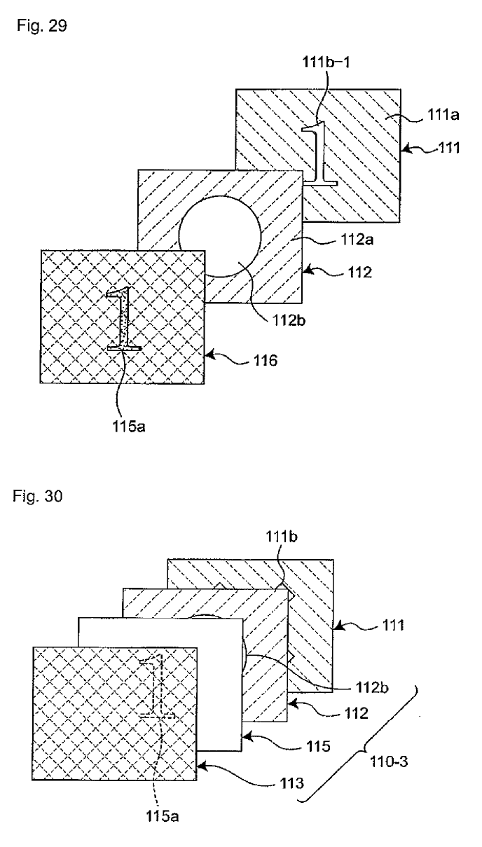

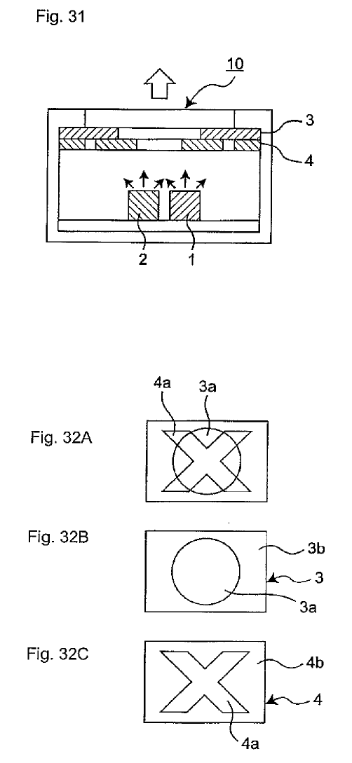

In the display filters 110-1 and 110-2, the display design pattern 115a is different from the design patterns 111b and 112b of the design pattern filters 111 and 112. Alternatively, as shown in FIG. 29, the display design pattern 115a can be formed into the same shape and size as the design pattern 111b-1 formed in the blue design pattern filter 111. The display design pattern 115a conforms to the design pattern 111b in the design pattern filter 111 or the design pattern 112b of the design pattern filter 112, luminance of the display design pattern 115a can be enhanced by the source light beam from the light source 120 and the outer peripheral light beam.

In the second embodiment, the achromatic filter 115 including the display design pattern 115a is disposed on the visibility side 192 of the blindfold filter 113. Alternatively, as shown in FIG. 30, the achromatic filter 115 may be disposed on the side of the light source 120 of the blindfold filter 113. That is, the achromatic filter 115 can be disposed between the blindfold filter 113 and the design pattern filter 112, the achromatic filter 115 can be disposed between the design pattern filter 112 and the design pattern filter 111, or the achromatic filter 115 can be disposed on the side of the light source 120 of the design pattern filter 111. FIG. 30 shows a display filter 110-3 in which the achromatic filter 115 can be disposed between the blindfold filter 113 and the design pattern filter 112.

The invention can be applied to the display filter which displays the plural design patterns at the same display pointing the switching manner and the display module provided with the display filter.

What is claimed is:

1. A display filter comprising:
a plurality of design pattern filters which are overlapped with each other; and
a blindfold filter which is disposed on a visibility side while overlapped with the plurality of design pattern filters, the visibility side being located across the plurality of design pattern filters from a light source,
wherein the design pattern filter has a design pattern which transmits a source light beam having a specific wavelength range, the design pattern filter is an absorption type filter which absorbs the source light beam having the specific wavelength range in a basis material portion outside the design pattern, the design pattern filters have design patterns different from each other, and the design pattern filters absorb the source light beams having the specific wavelength ranges to display the different design patterns respectively, and
the blindfold filter is a filter which prevents an outer peripheral light beam from causing the plurality of design patterns to become visible when the source light beam is turned off, the blindfold filter transmits the source light beam having the specific wavelength range transmitted through each design pattern, and the blindfold filter absorbs light beams having wavelength range out of each specific wavelength range.

2. The display filter according to claim 1, wherein the design pattern filters and the blindfold filter are integrally formed in one sheet material.

3. The display filter according to claim 2, wherein the design pattern filter and the blindfold filter are integrally formed in one sheet material by ink printing.

4. The display filter according to claim 1, further comprising an achromatic filter which is disposed on he visibility side or a light source side of the blindfold filter, the achromatic filter including a display design pattern which becomes visible when the outer peripheral light beam exists while the source light beam is turned off.

5. The display filter according to claim 4, wherein the display design pattern is formed by performing ink printing to the blindfold filter.

6. The display filter according to claim 4, wherein the display design pattern in the achromatic filter is formed by performing ink printing or vacuum plating to a transparent or translucent sheet material.

7. The display filter according to claim 4, wherein the display design pattern in the achromatic filter is identical to one of the design patterns in the design pattern filter.

8. The display filter according to claim 1, wherein the specific wavelength ranges of the source light beams absorbed by the design pattern filters are different from each other, and the specific wavelength ranges are not overlapped with each other.

9. The display filter according to claim 1, wherein the specific wavelength ranges of the source fight beams absorbed by the design pattern filters are overlapped in a boundary region.

10. The display filter according to claim 1, wherein the design patterns formed in the design pattern filters are disposed at an identical point while overlapped with each other.

11. The display filter according to claim 1, wherein the design patterns formed in the design pattern filters are disposed at positions different from each other while not overlapped with each other.

12. A display module comprising:
the display filter according to claim 1; and
a light source which emits a source light beam having a specific wavelength range, the source light beam having a specific wavelength range being absorbed by the design pattern filters included in the display filter.

13. The display module according to claim 12, wherein the plurality of light sources are provided, each light source emits a source light beam corresponding to a specific wavelength range absorbed by each design pattern filter, and
the display module further includes a selector switch which switches the light source to be emitted, the selector switch displaying a design pattern in a design pattern filter corresponding to the source light beam emitted from the light source.
